(19) United States
(12) Patent Application Publication
(10) Pub. No.: US 2026/0348782 A1
(43) Pub. Date: Nov. 5, 2026

(54) GAS TYPE COMPENSATION FOR MEMS DEVICE

(71) Applicant: VAT HOLDING AG, Haag (CH)

(72) Inventor: Christian PETERS, Zürich (CH)

(21) Appl. No.: 19/124,684

(22) PCT Filed: Oct. 27, 2022
(86) PCT No.: PCT/EP2022/080114

§ 371 Date: Apr. 25, 2025

(51) Int. Cl. G01L 9/12; G01L 9/00; G01N 11/16

(52) U.S. Cl. CPC G01L 9/12; G01L 9/0005; G01N 11/16

(57) ABSTRACT

A controlling and processing unit for a gauge system includes at least a first sensor comprising a membrane, a suspension of the membrane, a bottom wafer, and a cavity being formed between the membrane and at least a portion of the bottom wafer. The gauge system includes an oscillation generator unit configured to set at least the membrane in oscillation. The controlling and processing unit is configured to provide driving the oscillation generator unit in a first oscillation mode and in a second oscillation mode, measuring a first damping response during applying the first oscillation mode, measuring a second damping response during applying the second oscillation mode, jointly processing the first damping response and the second damping response and deriving at least a value for the pressure and/or molecular parameter based on the joint processing.

The invention relates to a measuring method with a microelectromechanical system (MEMS) sensor. It relates to a device that comprises an oscillating or otherwise movable element, such as a resonator membrane.

Microelectromechanical systems are routinely used in many devices that combine mechanical and electronic functionalities on a size scale in the range of a few micrometers to a few millimetres. Some examples of the broad applications field of MEMS devices are sensors, actuators, oscillators and applications in the field of microfluidics.

Pressure gauges are a key element in operating and controlling modern vacuum systems. Such systems are of highest importance in a variety of industries, such as the coating-, automotive-, optical- and semiconductor industry, or in the production of solar cells and medical devices. In all these industries, a reliable measurement of the pressure within a vacuum chamber is mandatory in order to monitor or control process steps that have to be carried out under reduced pressure.

Nowadays, there are various pressure gauges available that differ in their basic measurement principle, the addressed pressure range, their handling, and their reliability. In particular, MEMS pressure gauges are available, for example gauges that comprise a suspended resonator in combination with a friction/squeeze-film, below referred to as “squeeze-film”.

The characteristics and reliability of MEMS devices comprising small sized components depend strongly on size variations in the micrometer regime. This leads to high demands concerning device layout and fabrication process. In the case of a squeeze-film type pressure gauge, the interaction of the sensing element with the gas molecules, in particular the gas molecules forming the squeeze-film, needs to be optimized. This can be done by a resonantly oscillating membrane being at a well-defined distance in the range of a few micrometers to a substrate and extending over a large area parallel to the substrate, i.e. by forming a cavity having an aspect ratio between an extension of the membrane parallel to the substrate and the distance of the membrane to the substrate of more than 100, for example.

Further, the membrane needs to show appropriate resonance modes which can be achieved by loading the membrane with a suitable mass. Preferably, this is done in a process step that is easy to integrate in the overall fabrication process of the pressure gauge or its pressure transducer (sensor) and that allows for an easy adaption of the mass. As for example, a respective friction/squeeze-film gauge type sensor element is known from U.S. Pat. No. 11,118,991 B2 . Here, the measurement method is based on the influence of ambient pressure on the system properties (such as resonance frequency, Q-factor) of a micro-resonator. In this, an appropriately designed cavity gives the space required for an oscillation of a resonator or resonator element comprising a membrane that is possibly loaded by a mass and the oscillation properties of the resonator or resonator element are indicative of the pressure. The cavity, especially in the form of a thin gas film cavity, forms gap near the resonator and causes pressure dependent squeeze-film damping of the resonator, so that the measured system properties are indicative of the pressure.

In particular, a MEMS sensor according to the state of the art may be calibrated for use in defined process atmosphere with known gas species and thus provides accurate measurement values.

However, as mentioned, the interaction of the gas molecules with the sensing element affects the damping behaviour of the system. In consequence, such damping depends not only on the amount of molecules but also on the type of molecules present in the cavity. Hence, measuring the damping of the MEMS resonator can provide information about a pressure in the cavity, but such pressure measurement may also depend on the present gas species.

Such influence becomes even more relevant when using the MEMS sensor with application of varying or undefined gas species. This may lead to pressure measurements which differ from an actual pressure value due to the presence of unknown or undefined molecules or molecular compositions.

It is therefore an object of the present invention to provide an improved sensor which provides to overcome above-described disadvantages.

It is a further object of the present invention to provide an improved gauge which provides more reliable and accurate results.

It is a further object of the present invention to provide an improved sensor which provides additional information related to the present gas species.

These objects are achieved through the realisation of the characterizing features of the independent claims. Features that develop the invention further in alternative or advantageous manner can be gathered from the dependent claims.

The invention is based on the observation that a MEMS sensor for measuring e.g. pressure, in particular a pressure transducer, e.g. based on a squeeze-film, provides different sensitivities for different excitation frequencies. The sensitivity of such sensor should here be understood to be a relationship between a damping effect caused at an oscillating element of the sensor by a fluid in its cavity and a pressure of the fluid.

“Fluid” in context of the present invention should be understood to be a gas, a particular gas species, a composition of different gas species, a precursor, a liquid, or a combination of at least two of these.

The invention relates to a gauge system, in particular a pressure gauge system, comprising a controlling and processing unit and a first sensor, in particular a pressure transducer based on a squeeze-film. The first sensor comprises a membrane, a suspension of the membrane, the suspension allowing oscillation of the membrane, and a bottom wafer, wherein the suspension of the membrane is connected with the bottom wafer. The first sensor further comprises a cavity, the cavity being formed between the membrane and at least a portion of the bottom wafer. In particular, the transducer comprises an inlet connecting the cavity to a surrounding. In particular, a structured top wafer provides the membrane and the suspension of the membrane.

The gauge system comprises an oscillation generator unit configured to set at least the membrane in oscillation.

According to the invention, the controlling and processing unit is configured to provide
driving the oscillation generator unit in a first oscillation mode and in a second oscillation mode,
measuring a first damping response during applying the first oscillation mode, the first damping response depends on a molecular parameter related to the fluid and on a pressure parameter related to the fluid,
measuring a second damping response during applying the second oscillation mode, the second damping response depends on the molecular parameter related to the fluid and on the pressure parameter related to the fluid,
jointly processing the first damping response and the second damping response and
deriving at least a value for the pressure parameter and/or a value for the molecular parameter based on the joint processing.

By performing the above steps by means of the controlling and processing unit a compensated measuring of the pressure of the fluid can be provided.

In one embodiment, the sensor can contain a resonator (membrane) with a large surface area suspended over a small air gap (cavity) with and aspect ratio of >10:1, preferably >100:1, preferably >1000:1. The suspension can be asymmetric or symmetric, preferably asymmetric.

The resonator can be excited via electrostatic forces or, alternatively, it may also be excited mechanically (externally).

The sensor readout (damping response) can be performed by a capacitive readout scheme. In one embodiment, it can also be read out by optical, piezoelectric, or piezo-resistive means. An electrode layout for exciting and/or capacitive readout can be symmetric or asymmetric, preferably asymmetric,

The sensor can be temperature-stabilized or non-stabilized, temperature-stabilized is preferred.

The bottom wafer should be understood to be any suitable kind of base or substrate according to the state of the art, but does not necessarily have to be a crystalline-based substrate.

In one embodiment, jointly processing the first damping response and the second damping response can comprise considering different sensitivities of one or more sensors. Each of these sensitivities also depends on the type of fluid (e.g. gas species) present in the cavity.

The different sensitivities can be provided by driving the oscillation generator unit in a first oscillation mode and in a second oscillation mode.

The difference in gas-species sensitivity can be realized using a single resonating member (simultaneously) excited at two or more oscillation modes. Additionally or alternatively, two or more resonating members (membranes) can (simultaneously) be excited at one or more oscillation modes. These two members can be placed on a single MEMS chip or on several physically separated MEMS chips. The members can be electrically connected to one or more dedicated readout electronic units in series or parallel connection. Two transducers (sensors) can use the same or different oscillation modes.

By such combination of two gas-species-sensitive pressure signals compensation of the gas type dependence can be provided and a pressure signal can be obtained independent of at least molecular weight.

Additionally or alternatively, a determination of gas species becomes available by deriving the molecular parameter (e.g. average molecular weight) .

The sensor, i.e. the membrane, can be driven to oscillate in a desired oscillation mode (e.g. having defined frequency, amplitude, direction of oscillation etc.) . By that a particular sensitivity of the sensor is provided.

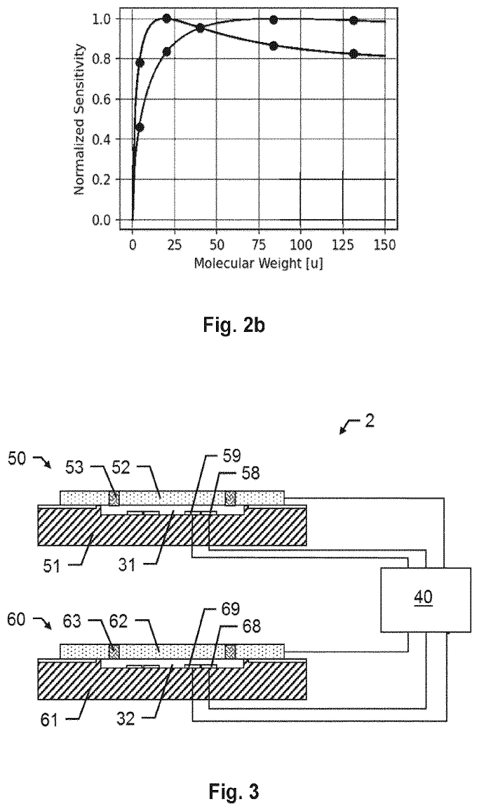

Such sensitivity is preferably determined in advance of measuring. In other words, the sensor and one or more particular excitations are calibrated. The calibration can be performed by measuring the sensitivities by measuring one (or more) actuation voltage(s) (damping response) at one (or more) pressure point(s) for several different fluids (e.g. gases). Based on that, the relation between the sensitivity and the molecular parameter can be fitted (see FIGS. 2a and 2b).

In one embodiment, the gauge system comprises one or more additional sensors, the one or more additional sensors is/are configured according to the first sensor of above. The oscillation generator unit comprises first oscillation generator configured to set the membrane of the first sensor in oscillation and a second or more oscillation generator configured to set the membrane of the one or more additional sensor in oscillation.

In particular, the first oscillation mode is provided by driving the first oscillation generator and the second oscillation mode is provided by driving the second or more oscillation generator.

By providing at least two sensors (pressure transducers), two sensitivities can be provided simultaneously by driving each of the two sensors in a particular oscillation mode.

This provides robust and precise measurement due to initial avoidance of any interactions between the oscillation modes.

According to one embodiment, the gauge system can provide for measuring a pressure of a fluid in the cavity. Here, the gauge system represents a pressure gauge system.

According to one embodiment, the gauge system can provide for measuring a molecular weight, in particular an average molecular weight, of a fluid in the cavity. This may allow to derive a particular type of fluid, in particular a gas species. Here, the gauge system represents a gas detection unit.

According to one embodiment, the gauge system can provide for measuring a molecular weight and a pressure of the fluid in the cavity.

The invention also relates to a controlling and processing unit for a gauge system, in particular for a pressure gauge system. The gauge system comprises at least a first sensor, in particular a pressure transducer, which comprises a membrane, a suspension of the membrane, wherein the suspension allowing oscillation of the membrane, and a bottom wafer, wherein the suspension of the membrane is connected (directly or by means of a connector) with the bottom wafer. The sensor also comprises a cavity, the cavity being formed between the membrane and at least a portion of the bottom wafer. In particular, the transducer comprises an inlet connecting the cavity to a surrounding. In particular, a structured top wafer provides the membrane and the suspension of the membrane. The gauge system further comprises an oscillation generator unit configured to set at least the membrane in oscillation.

The controlling and processing unit is configured to provide:
driving the oscillation generator unit in a first oscillation mode and in a second oscillation mode,
measuring a first damping response during applying the first oscillation mode, the first damping response depends on a molecular parameter related to a fluid to be measured (in particular present in the cavity) and on a pressure parameter related to the fluid,
measuring a second damping response during applying the second oscillation mode, the second damping response depends on the molecular parameter related to the fluid and on the pressure parameter related to the fluid,
jointly processing the first damping response and the second damping response and
deriving at least a value for the pressure parameter and/or a value for the molecular parameter based on the joint processing.

The controlling and processing unit can provide a compensated measuring of the pressure parameter (e.g. pressure) of the fluid by respectively controlling the sensor. Alternatively or additionally, the controlling and processing unit can provide a compensated measuring of the molecular parameter of the fluid by respectively controlling the sensor.

In particular, the controlling and processing unit according to the invention provides using the gauge system as a pressure gauge system and/or as a gas detection system.

Driving the oscillation generator unit in a first oscillation mode and/or in a second oscillation mode can be provided by applying an actuation signal (e.g. a varying actuation voltage) to the oscillation generator unit, in particular to an actuating electrode of the oscillation generator unit.

It is to be understood that a controlling and processing unit of a gauge system may be embodied according to a controlling and processing as described in the following.

In one embodiment, the controlling and processing unit is configured to derive a value for the molecular parameter based on the joint processing. This allows to also derive further information related to the fluid.

In one embodiment, the molecular parameter represents the molecular weight of the fluid. Hence, an average molecular weight of the fluid can be derived. In particular, a particular gas species can be identified by having information about the molecular weight.

According to one embodiment, the pressure parameter represents the pressure of the fluid. As already mentioned above, this way the pressure of the fluid can be derived.

In one embodiment, the driving of the oscillation generator unit in a first oscillation mode and/or in a second oscillation mode can be provided by applying or varying an actuating voltage for driving the oscillation generator unit, wherein the actuating voltage is applied or varied by use of a feedback loop. By that, the oscillation modes can be set and maintained in constant manner and desired oscillation of the membrane can be provided.

The gauge system, in particular the sensor, can comprise an actuating electrode for excitation of the oscillation modes. A respective actuation signal (actuation voltage) can be applied to the actuating electrode. The actuating electrode can be provided by the oscillation generation unit.

In particular, the actuation signal can be controlled by means of the feedback loop so that a phase relation between the actuation signal and the mechanical oscillation of the membrane is kept constant and/or a mechanical oscillation amplitude of the membrane is kept constant.

In particular, the first damping response and/or the second damping response can be measured by determining the actuation signal, in particular by means of the feedback loop.

In one embodiment, the first oscillation mode provides oscillation of the membrane with a first amplitude and a first frequency and the second oscillation mode provides oscillation of the membrane with a second amplitude and a second frequency, wherein at least the first frequency is different from the second frequency and/or the first amplitude is different from the second amplitude.

In one embodiment, the controlling and processing unit is configured to provide the oscillation of the membrane in the first oscillation mode in a first oscillation direction and the oscillation of the membrane in the second oscillation mode in a second oscillation direction, wherein the first oscillation direction is different from the second oscillation direction.

An oscillation direction can for example be an oscillation of the membrane out of plane, i.e. a positional variation of the membrane in a direction perpendicular to an extension of the membrane. Another oscillation direction can be a tilting of the membrane around an axis (short axis) laying in-plane of the membrane.

In one embodiment, the first damping response and/or the second damping response can be measured by capacitive measurement, wherein a capacitor for providing the Capacitive measurement is provided by the membrane and at least a portion of the bottom wafer.

The gauge system, in particular the sensor, can comprise a capacity electrode for measuring the damping response of an oscillation mode. A respective capacity can be measured by means of the capacity electrode.

According to one embodiment, the sensor can comprise a first capacitor for measuring the amplitude and/or frequency of the oscillation of the membrane relative to the bottom of the cavity. This first capacitor is for example formed by the following electrodes:
the membrane (in particular the surface of the membrane that is directed towards the cavity) and the bottom wafer, which includes a first capacitor formed by a portion of the membrane and/or a portion of the bottom wafer;
an electrode of a first kind and the membrane, wherein the electrode of the first kind is arranged at the bottom of the cavity;
the electrode of the first kind and the bottom wafer or a portion thereof, wherein the electrode of the first kind is arranged on the membrane; or
at least two electrodes of the first kind, wherein at least one electrode of the first kind is arranged on the membrane and at least one is arranged at the bottom of the cavity.

The first capacitor may further be connected to a control loop with which the amplitude and/or frequency of the oscillation of the membrane relative to the bottom of the cavity is measured.

The electrode of the first kind is herein also referred to as capacity electrode.

In one embodiment, the sensor comprises a second capacitor for actuating the membrane. The second capacitor is for example formed by the following electrodes:
the membrane (in particular the surface of the membrane that is directed towards the cavity) and the bottom wafer, which includes a second capacitor formed by a portion of the membrane and/or a portion of the bottom wafer;
an electrode of a second kind and the membrane, wherein the electrode of the second kind is arranged at the bottom of the cavity;
the electrode of the second kind and the bottom wafer or a portion thereof, wherein the electrode of the second kind is arranged on the membrane; or
at least two electrodes of the second kind, wherein at least one electrode of the second kind is arranged on the membrane and at least one is arranged at the bottom of the cavity.

The second capacitor can be part of an oscillation generator unit of may provide the oscillation generator unit that is equipped for exciting an oscillation of the membrane by applying an excitation voltage to at least one of the electrodes that form the capacitor. The frequency of the excitation voltage can be adapted to the pressure-dependent resonance frequency of an appropriate resonance mode of the possibly loaded membrane.

The electrode of the second kind is herein also referred to as actuating electrode.

Excitation and resonance frequencies in the range of 0.1 to 1000 kHz, in particular in the range of 1 to 100 kHz, are used, whereby it is the impact of the pressure/squeeze-film that leads to such frequency range.

The electrode(s) can be made of any conductive material that is vacuum compatible, in particular non-out-gassing at least up to 10⁻⁷ mbar, and that shows stable and pressure independent properties over a longer period of time. For example, the electrode may be made of doped silicon, Al, Ti, W, Au, Pt, Pd, Cr, Ta, Zr, or alloys thereof.

The sensor may comprise at least one electrode of a first kind and at least one electrode of a second kind. For example, an electrode of the first kind and an electrode of the second kind may be arranged on the membrane and share a Common electrode which is arranged on the bottom wafer or which is the bottom wafer itself.

The invention also relates to a method for measuring of a fluid by means of a gauge system. The gauge system comprises at least a first sensor (e. g. pressure transducer) and an oscillation generator unit. The first sensor comprises a membrane, a suspension of the membrane, the suspension allowing oscillation of the membrane, a bottom wafer, wherein the suspension of the membrane is connected with the bottom wafer, and a cavity, the cavity being formed between the membrane and at least a portion of the bottom wafer. In particular, the transducer comprises an inlet connecting the cavity to a surrounding. The oscillation generator unit is configured to provide oscillation of at least the membrane.

The method comprises the steps of
driving the oscillation generator unit in a first oscillation mode and in a second oscillation mode,
measuring a first damping response during applying the first oscillation mode, the first damping response depends on a molecular parameter related to the fluid and on a pressure parameter related to the fluid,
measuring a second damping response during applying the second oscillation mode, the second damping response depends on the molecular parameter related to the fluid and on the pressure parameter related to the fluid,
jointly processing the first damping response and the second damping response and
deriving at least a value for the pressure parameter based on the joint processing.

Driving the oscillation generator unit in a first oscillation mode and/or in a second oscillation mode can be provided by applying respective actuation signals (e.g. a varying actuation voltage) to the oscillation generator unit, in particular to one or more actuating electrodes of the oscillation generator unit.

In one embodiment, the gauge system can comprise one or more additional sensors (e.g. pressure transducers), the one or more additional sensors are configured according to any of the sensors described above. The oscillation generator unit can comprise a first oscillation generator configured to set the membrane of the first sensor in oscillation and a second or more oscillation generator configured to set the membrane of the one or more additional sensors in oscillation.

In particular, the first oscillation mode can be provided by driving the first oscillation generator and the second oscillation mode can be provided by driving the second or more oscillation generators.

In one embodiment, the method comprises a particular method step which provides a step which can be performed according to the configuration of the controlling and processing unit.

The invention also relates to a computer programme product comprising programme code which is stored on a machine-readable medium, or being embodied by an electromagnetic wave comprising a programme code segment, and having computer-executable instructions for performing and/or controlling the method of above, in particular when run on a controlling and processing unit of above.

Hence, the computer program product can be implemented to, when executed by the controlling and processing unit, cause the automatic execution of the steps of the method according to above.

The devices and method according to the invention are described or explained in more detail below, purely by way of example, with reference to working examples shown schematically in the drawings. Specifically,

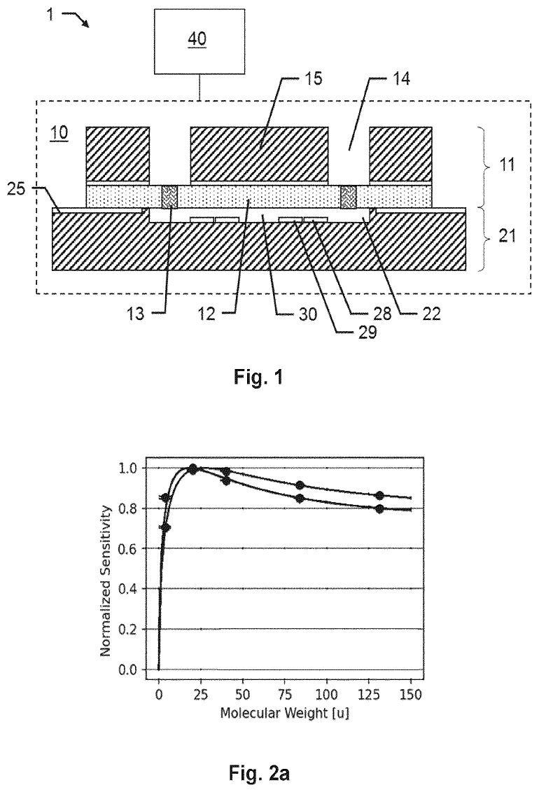

FIG. 1 shows an embodiment of a gauge system according to the invention in a schematic cross-sectional view;

FIGS. 2a-b show particular relationships between sensor sensitivities and gas species (molecular weight) ;

FIG. 3 shows an embodiment of a gauge system according to the invention; and

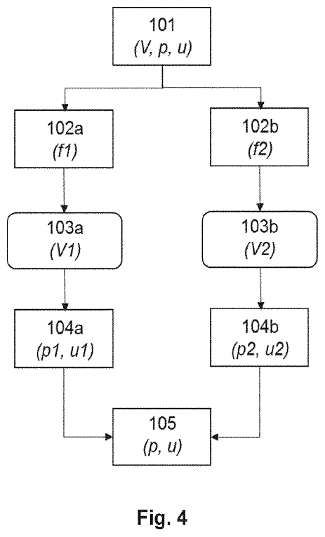

FIG. 4 shows a flow chart representing the steps for providing gas-compensated pressure measurement according to the invention.

FIG. 1 shows an embodiment of a gauge system 1 according to the invention in a schematic cross-sectional view.

The gauge system 1 comprises a sensor 10 having a top wafer 11 which is structured such that it comprises a membrane 12, a suspension 13 and an inlet 14. The sensor 10 can be embodied as a pressure transducer. The suspension 13 provides movability of the membrane 12, in particular an oscillation of the membrane 12. In the shown embodiment the membrane 12 is loaded by a mass 15. However, according to alternatives embodiments, a membrane may be provided as an exclusive oscillation element, in particular without having additional masses or the like.

The sensor 10 comprises a bottom wafer 21 which is structured such that it comprises a device recess 22 which forms the bottom and side walls of a cavity 30. The depth of the device recess 22 can be chosen such that a friction/squeeze-film can be established. “Top” and “bottom” wafers should not be understood to the transducer has necessarily to be aligned such that the top wafer is above the bottom wafer in a vertical direction, but should be understood as respective terms for simply naming the respective components.

The top wafer 11 and the bottom wafer 21 are bonded together such that all portions of the membrane 12 and all portions of the suspension 13 are positioned above the device recess 22. The cavity 30 is between the membrane 12 and a portion of the bottom wafer 21.

In order to fabricate a cavity in accordance to the functionality of the sensor, i.e. the membrane and its suspension are not in direct contact with the bottom wafer, the top wafer may be positioned relative to the bottom wafer before bonding such that all portions of the suspension and its membrane lie on top of the device recess. This also means that it is the membrane that forms the top of the cavity.

In one embodiment, an extension of the cavity 30 along an axis perpendicular to the large surface of the membrane (“vertical” extension) may be small, so that the cavity 30 is a small gap only. For example, this extension may be less than 20 μm, especially less than 10 μm or at most 5 μm and at least 0.7 μm or at least 1 μm.

The top wafer 11 also comprises an inlet 14 to provide a connection of the cavity 30 with the surrounding of the transducer 10.

The inlet 14 connects the cavity 30 to the surrounding atmosphere and ensures that a pressure equalization between surrounding area and cavity 30 takes place. In an embodiment of the sensor 10, the inlet 14 is an opening through the whole top wafer, wherein the opening separates the membrane (and mass, if present) from the rest of the top wafer. This means that the inlet 14 is in particular a gap that surrounds the membrane 12 except in the region of the suspension 13. In other embodiments, the inlet 14 may be formed by channels in the top wafer. In yet other embodiments, the inlet may be formed by corresponding channels in the bottom wafer as well.

According to an alternative, the elements of the sensor 10, in particular the membrane 12, the suspension 13 and the cavity 30 may be provided by a different approach according to known fabrication processes of the state of the art (e.g. additive structuring), i.e. not necessarily being provided by the top and the bottom wafer.

The membrane 12 forms part of a resonator by being capable of being set in oscillation. In the shown embodiment, the membrane 12 has a round shape and hence is disk-like. The diameter of the disk-like membrane 12 may be between 100 pm and 1.0 mm, especially between 200 μm and 5 mm and between 500 μm and 5 mm.

However, according to alternative embodiments a membrane of arbitrary shape as well as membranes of for example rectangular or elliptical shape are possible.

In the present example, an oscillation generation unit is provided by actuating electrodes 28 in the bottom of the device recess 22. The actuating electrodes 28 serve to actuate the membrane 12 by applying a respective actuation signal.

The sensor 10 also comprises capacity electrodes 29 constitute one electrode of a capacitor for measuring an amplitude and a frequency of an oscillation of the membrane 12. The other electrode of the capacitor is given by the membrane 12. Respective contacting pads 25 are embedded into the bottom wafer 21.

In one embodiment, the sensor 10 can comprise at least one electrode, wherein the at least one electrode and the membrane 12 form at least one capacitor for actuating and measuring an amplitude and/or a frequency of an oscillation of the membrane 12 relative to the bottom of the cavity 30. In particular, the at least one electrode is arranged at the bottom of the cavity 30, e. g. in the form of a conductive area, or the bottom wafer 21 or parts thereof are used as the at least one electrode.

In the embodiment shown in FIG. 1, the bottom wafer 21 is a Si-wafer where a thermal oxide was grown after etching, in particular of the of device recess 22, in order to isolate conductor lines, electrodes 28,29 and contacting pads 25 from each other. Alternatively, the top and/or bottom wafer are in particular, crystalline or polycrystalline Si-wafers, SOI-wafers or CMOS wafers.

However, they can also be made of a material different to Si, e.g. of glass.

The gauge system 1 also comprises a controlling and processing unit 40. The controlling and processing unit 40 is connected with the sensor 10.

The controlling and processing unit 40 is configured to provide desired oscillation of the membrane 12 by applying a particular excitation signal to the oscillation generation unit, i.e. to the actuating electrodes 28. By that different oscillation modes can be applied to the membrane 12. As for example the membrane can be oscillated with different frequencies and/or, amplitudes and/or can provide oscillations according to different types of membrane movement. The membrane 12 can be moved out-of-plane, i.e. vibrating in a direction perpendicular to the extension of the membrane, or can be tilted around an in-plane axis, i.e. tilting-oscillation.

In one embodiment, at least two oscillation modes can be applied simultaneously, By that a superimposed oscillation can be provided.

### (pressure) Measurement Based on Squeeze Film Damping of a

resonating membrane (resonator) is also sensitive to the gas species and, in particular to properties of the sensor. Gas-species sensitivity is preferably related to molecular weight. Relevant sensor parameters can relate to geometric aspects like gap size, resonator area and resonator shape, as well as resonance frequency, and oscillation mode.

The gas species sensitivity can be measured by measuring one (or more) actuation voltage(s) at one (or more) pressure point(s) for several different gases.

The relationship between sensitivity and gas species (molecular weight) is exemplarily shown with FIGS. 2a and 2b. The sensitivity is different for different frequencies and different sensor modes. Here, for each vibration mode, the relation between sensitivity and molecular weight is fitted. A non-linear, three parameter, physics based model can be applied for fitting. However, fitting may be performed in alternative way according to known principles in the art.

FIG. 2a exemplarily shows two fitted sensitivities curves over molecular weight. The two sensitivities are related to two different sensors used of respective measurements. Each sensor was excited with a different excitation frequency.

FIG. 2b also exemplarily shows two fitted sensitivities curves over molecular weight. The two sensitivities curves are related to different oscillation modes applied to the same sensor. The sensor was once excited in an out-of-plane mode and in addition excited in a tilting vibration mode.

Both oscillations were performed at different frequencies. For each oscillation mode, there are two (initially unknown) inputs pressure of the fluid and molecular weight of the fluid. In addition, there is one output that can be measured: voltage. As a consequence the system remains underdetermined when measuring (only) one damping response (voltage).

According to solutions known in the art, such sensors (preferably pressure transducers) are used in well-known and/or well-defined atmospheric regimes which allows to define or chose the gas species (and hence the molecular weight) present in the cavity. Knowing the gas type (or a small number of gas types possibly being present) allows to directly determine the pressure. However, this is not reliable or even impossible when using the sensor in an undefined atmosphere without having information about a gas type or composition of gas types.

Herein, the relationship between the damping response (in particular corresponding to an actuation voltage measured by means of one of the capacitors) and pressure is referred to as sensitivity. As mentioned, this sensitivity is also dependent on the gas species.

In one embodiment, the approach according to the invention provides considering the dependency of the sensitivity on particular gas species (molecular weights) and to compensate a pressure measurement respectively.

The controlling and processing unit 40 is configured to drive the oscillation generator unit 28 in a first oscillation mode and in a second oscillation mode. While applying the first oscillation mode, a first damping response is measured. Such measurement can in particular be provided by the capacity electrodes 29. Accordingly, the controlling and processing unit 40 is configured measure a second damping response during applying the second oscillation mode.

The first and second damping response each depend on a molecular parameter related to the fluid in the cavity and on a pressure parameter related to the fluid in the cavity. As a consequence thereof, when measuring only one damping response there still exist two undetermined parameters (molecular and pressure parameter) not allowing to accurately determining one of those. The molecular parameter may be the molecular weight and the pressure parameter may be the pressure of the fluid.

One can now process two (or more) oscillation modes (with different characteristics) and the respective damping responses to obtain a determined (or even overdetermined) system. This allows to extract (compute) the pressure parameter and the molecular parameter. Using three or more oscillation modes and damping responses can provide even more robust and accurate results, in particular because the relationship between sensitivity and molecular weight is non-linear.

Accordingly, the controlling and processing unit 40 is configured to provide compensated measuring of pressure of the fluid and/or of molecular weight of the fluid by jointly processing the first damping response and the second damping response and deriving at least a value for the pressure parameter and/or for the molecular parameter based on the joint processing.

Respective sensitivities may be derived and pre-known by performing an in-advance calibration step for the applied measuring excitation frequencies.

FIG. 3 shows an embodiment of a gauge system 2 according to the invention. The gauge system 2 comprises a first 50 and one additional sensor 60 and a controlling and processing unit 40.

The first sensor 50 comprises a membrane 52 and a suspension 53 for the membrane, providing movability (oscillation) of the membrane 52. Further, the transducer 50 comprises a base substrate 51 (bottom wafer) having a recess. The membrane 52 is mounted to the base substrate 51 such that a cavity 31 is provided between the membrane 52 and the bottom of the recess of the base substrate 51.

The additional sensor 60 comprises a membrane 62 and a suspension 63 for the membrane 62, providing movability (oscillation) of the membrane 62. Further, the transducer 60 comprises a base substrate 61 (bottom wafer) having a recess. The membrane 62 is mounted to the base substrate 61 such that a cavity 32 is provided between the membrane 62 and the bottom of the recess of the base substrate 61.

The gauge system 2 also comprises actuating electrodes 58 and 68 and capacity electrodes 59 and 69. The electrodes 58,59, 68, 69 are connected to the controlling and processing unit 40.

In one embodiment, the actuating electrodes 58 and 68 can provide the oscillation generator unit, in particular together with the controlling and processing unit 40. In one embodiment, the oscillation generator unit can be implemented together with the controlling and processing unit 40 and the actuating electrodes 58 and 68 may be considered to be part the sensor. Both these embodiments are within the scope of the present invention.

The controlling and processing unit 40 is configured to provide oscillation of the membranes 52 and 62 by applying respective actuating signals by means of the actuating electrodes 58 and 68 (and in particular by the membranes 52 and 62). By that, the membrane 52 can be excited to provide a first oscillation mode and the membrane 62 can be excited to provide a second oscillation mode.

The oscillation modes can provide different sensitivities due to e.g. different excitation frequencies and/or different structural properties of the transducers 50, 60.

Damping of the membrane oscillations are caused by a particular fluid present in the cavities 31 and 32. In the present embodiment, both transducers 50 and 60 are situated in a common atmospherically environment, i.e. the fluid in the cavities 31 and 32 is identical at least with respect to chemical composition and/or pressure.

The damping effect (damping response) can be measured by the controlling and processing unit 40 either by means of the actuating electrodes 58, 68 and/or by means of capacity electrodes 59, 69.

In case of measuring the damping via the actuating electrodes 58, 68 a feedback signal of a feedback loop, which allows to keep the oscillation stable, is processed and the damping effect can be derived depending on the amount of energy necessarily to be put in the system to provide stable oscillation and thus to overcome damping effects.

In case of measuring the damping via the capacity electrodes 59, 69 the combination of the respective membranes 52, 62 and capacity electrodes 59, 69 provides respective capacitors and the damping effects can be derived by measuring capacitive changes for the capacitors. Accordingly, in one embodiment of the invention, at least one sensor comprises an actuating electrode only. Respective capacity electrode may be omitted.

FIG. 4 shows a flow chart representing the steps for providing gas-compensated pressure measurement according to the invention with a sensor.

Initially at least one sensor can be provided in an atmosphere the pressure of which should be determined. The fluid (a particular gas species or a composition of gas species) in the atmosphere enters the cavity of the sensor through the inlet.

The starting point 101 for performing a respective measurement is the above-described relationship between a pressure p of the fluid, a (average) molecular weight u of the fluid and a respective damping effect caused by the fluid. The damping can be measured by means of the sensor by measuring a voltage V, e.g. by means of a feedback loop. The sensor, in particular the membrane of the sensor or several membranes in case of using more than one sensor, is excited to oscillate in two particular oscillation modes (102a and 102b) with different frequencies f1 and f2. This means that two such relationships between pressure p, molecular weight u and voltage V are considered, resulting in six initially unknown parameters.

In steps 103a and 103b for each of the excitations a respective damping response represented by voltages V1 and V2 can be measured. By that, two of six parameters are determined.

This results to still non-determined influences of the molecular weights u1 and u2 on the pressures pl and p2 as depicted with steps 104a and 104b. Since the present fluid is necessarily the same for both oscillation modes, the pressures and the molecular weights has to be identical.

Hence, this results to a mathematical system which is determined and can be solved. As a result, in step 105, a value for the pressure p and also a value for the molecular weight u can be derived.

As a consequence, the pressure of the fluid can be derived by making use of different sensitivities of the sensor when applying different oscillation modes, e.g. different frequencies and/or different oscillation directions (out-of-plane or tilt).

Additionally or alternatively, the molecular weight of the fluid can be derived by making use of different sensitivities of the sensor when applying different oscillation modes, e.g. different frequencies and/or different oscillation directions (out-of-plane or tilt).

Respective information about the molecular weight allows to determine a particular type of fluid present in the cavity. Although the invention is illustrated above, partly with reference to some specific embodiments, it must be understood that numerous modifications and combinations of different features of the embodiments can be made and that the different features can be combined with each other or with vacuum applications known from prior art.

1. A controlling and processing unit for a gauge system, the gauge system comprising:
at least a first sensor comprising:
a membrane;
a suspension of the membrane the suspension allowing oscillation of the membrane a bottom wafer wherein the suspension of the membrane is connected with the bottom wafer; and
a cavity the cavity being formed between the membrane and at least a portion of the bottom wafer
wherein a structured top wafer provides the membrane and the suspension of the membrane; and
an oscillation generator unit configured to set at least the membrane in oscillation;
wherein the controlling and processing unit is configured to provide:
driving the oscillation generator unit in a first oscillation mode and in a second oscillation mode;
measuring a first damping response during applying the first oscillation mode, the first damping response depends on a molecular parameter related to a fluid to be measured and on a pressure parameter related to the fluid;
measuring a second damping response during applying the second oscillation mode, the second damping response depends on the molecular parameter related to the fluid and on the pressure parameter related to the fluid;
jointly processing the first damping response and the second damping response; and
deriving a value for the pressure parameter and/or a value for the molecular parameter based on the joint processing.

2. The controlling and processing unit according to claim 1,
wherein the molecular parameter represents the molecular weight of the fluid.

3. The controlling and processing unit according to any claim 1,
wherein the pressure parameter represents the pressure of the fluid.

4. The controlling and processing unit according to any claim 1,
wherein driving the oscillation generator unit in a first oscillation mode and/or in a second oscillation mode is provided by applying or varying an actuation signal for driving the oscillation generator unit and wherein the actuating voltage is applied or varied by use of a feedback loop.

5. The controlling and processing unit according to claim 4,
wherein the actuating voltage is controlled by means of the feedback loop so that
a phase relation between the actuation signal and the mechanical oscillation of the membrane is kept constant, and/or
a mechanical oscillation amplitude of the membrane is kept constant.

6. The controlling and processing unit according to claim 4,
wherein the first damping response and/or the second damping response is measured by determining the actuation signal, by means of the feedback loop.

7. The controlling and processing unit according to claim 1,
wherein the first oscillation mode provides oscillation of the membrane with a first amplitude and a first frequency and the second oscillation mode provides oscillation of the membrane with a second amplitude and a second frequency, and
wherein at least the first frequency is different from the second frequency and/or the first amplitude is different from the second amplitude.

8. The controlling and processing unit according to claim 1,
wherein the controlling and processing unit is configured to provide the oscillation of the membrane in the first oscillation mode in a first oscillation direction and the oscillation of the membrane in the second oscillation mode in a second oscillation direction, and
wherein the first oscillation direction is different from the second oscillation direction.

9. The controlling and processing unit according to claim 1,
wherein the first damping response and/or the second damping response is measured by capacitive measurement, and
wherein a capacitor for providing the capacitive measurement is provided by the membrane and at least a portion of the bottom wafer.

10. A gauge system comprising:
at least a first sensor the first sensor comprising:
a membrane;
a suspension of the membrane;
the suspension allowing oscillation of the membrane;
a bottom wafer wherein the suspension of the membrane;
is connected with the bottom wafer; and
a cavity the cavity being formed between the membrane
and at least a portion of the bottom wafer in particular wherein a structured top wafer provides the membrane and the suspension of the membrane; and
an oscillation generator unit configured to set at least the membrane in oscillation,
wherein the gauge system comprises a controlling and processing unit according to claim 1.

11. The gauge system according to claim 10, wherein
the gauge system comprises one or more additional sensors the one or more additional sensors are configured according to the first sensor of claim 10, and
the oscillation generator unit comprises:
a first oscillation generator configured to set the membrane of the first sensor in oscillation; and
a second or more oscillation generators configured to set the membrane of the one or more additional sensors in oscillation.

12. The gauge system according to claim 11, wherein
the first oscillation mode is provided by driving the first oscillation generator, and
the second oscillation mode is provided by driving the second or more oscillation generators.

13. A method for measuring of a fluid by means of gauge system the gauge system comprising at least a first sensor and an oscillation generator unit the first sensor comprising:
a membrane;
a suspension of the membrane the suspension allowing oscillation of the membrane;
a bottom wafer, wherein the suspension of the membrane is connected with the bottom wafer; and
a cavity the cavity being formed between the membrane and at least a portion of the bottom wafer,
wherein the oscillation generator unit being configured to provide oscillation of at least the membrane and
wherein the method comprising the steps of:
driving the oscillation generator unit in a first oscillation mode and in a second oscillation mode;
measuring a first damping response during applying the first oscillation mode, the first damping response depends on a molecular parameter related to the fluid and on a pressure parameter related to the fluid;
measuring a second damping response during applying the second oscillation mode, the second damping response depends on the molecular parameter related to the fluid and on the pressure parameter related to the fluid;
jointly processing the first damping response and the second damping response; and
deriving at least a value for the pressure parameter and/or a value for the molecular parameter based on the joint processing.

14. The method according to claim 13, wherein
the gauge system comprises one or more additional sensors, the one or more additional sensors are configured according to the sensor of claim 10, and
the oscillation generator unit comprises:
a first oscillation generator configured to set the membrane of the first sensor in oscillation; and
a second or more oscillation generators configured to set the membrane of the one or more additional sensor in oscillation;
the first oscillation mode is provided by driving the first oscillation generator; and
the second oscillation mode is provided by driving the second or more oscillation generators.

15. A computer program product comprising program code which is stored on a machine-readable medium, comprising:
a program code segment, and having computer-executable instructions for performing and/or controlling the method according to claim 13, when run on a controlling and processing unit according.
